(19) United States
(12) Patent Application Publication
(10) Pub. No.: US 2026/0176081 A1
(43) Pub. Date: Jun. 25, 2026

(54) DAMPER FOR A VIBRATING MACHINE AND VIBRATING MACHINE

(71) Applicant: Jöst GmbH + Co. KG, Dülmen (DE)

(72) Inventor: Thomas HYPKI, Dülmen (DE)

(21) Appl. No.: 19/218,934

(22) Filed: May 27, 2025

(30) Foreign Application Priority Data
May 27, 2024 (DE) 10 2024 114 772.5

(51) Int. Cl. B65G 27/30; B07B 1/28; F16F 7/10; F16F 7/112; F16F 7/116

(52) U.S. Cl. CPC B65G 27/30; F16F 7/1017; F16F 7/112; F16F 7/116; B07B 1/28; B65G 2812/0364

(57) ABSTRACT

The present invention relates to a damper for a vibration machine, in particular for a vibrating conveyor for conveying bulk material and/or for a screening machine for screening bulk material, having a compensation system for compensating vibration forces generated by a vibrating mass. According to the invention, the compensation system has at least one spring with modifiable spring hardness.

### CROSS-REFERENCE TO RELATED APPLICATIONS

This application claims the benefit under 35 U.S.C. 119(a) to German Patent Application No. 10 2024 114 772.5, filed 27 May 2024, which is incorporated herein by reference in its entirety.

### BACKGROUND

The present invention relates to a damper for a vibration machine and to a vibration machine having a damper.

A vibration machine in the sense of the present invention is a machine for processing bulk material which operates according to the vibration principle and/or in which a part of the machine is set into vibration in order to thereby move the bulk material. Examples of a vibration machine are vibrating conveyors and screening machines. Vibrating conveyors have a conveying trough which is set into vibration so that bulk material is conveyed in the conveying trough. In the case of screening machines, a screen is set into vibration so that bulk material is screened and/or sorted according to grain size.

For the function of a vibration machine, it is necessary that it is supported elastically on the ground. This takes place with spring elements, such as e.g. coil springs or rubber springs. Due to the periodic loading of the spring elements during vibrations of the vibration machine, the foundation is likewise loaded—so-called dynamic foundation loads thus occur.

These dynamic foundation loads constitute a high load for the foundation and require in particular a corresponding dimensioning of the buildings in which the vibration machine is installed. Often, these forces propagate in the building structure and the further surroundings of the vibration machine and cause vibrations which can have a negative effect on people and apparatuses.

In the prior art, it is therefore usual to reduce or compensate the dynamic foundation loads by anti-phase movements of special assemblies of the vibration machines. These assemblies are referred to as dampers or dynamic vibration dampers.

The design of vibration machines with integrated dampers is common. An integrated damper is designed to compensate the dynamic foundation loads by an antiphase vibrating system. This compensation is rigid and no adaptation to changing loads can take place. Thus, in the case of increased material load, the compensation is disturbed and does not act to the desired extent.

In particular when an adaptation of the rotational speed of a drive setting the vibration machine into vibration is necessary, the integrated dampers with rigid compensation known from the prior art cannot operate optimally and/or cannot compensate the dynamic foundation loads optimally. The change in the rotational speed is necessary in particular in vibration machines designed as resonance machines in order to prevent damage to the vibration machine due to large vibration ranges. Such large vibration ranges can arise, for example, when conveyed material adheres to the machine or the conveying trough and changed vibration conditions arise due to this material coupling.

### SUMMARY

It is therefore an object underlying the present invention to provide a solution which enables an improved vibration compensation, in particular an improved reduction and/or compensation of the dynamic foundation loads generated by a vibration machine and/or an adaptation of the vibration compensation to a changed vibration behavior during the operation of a vibration machine.

The object underlying the invention is solved by a damper or a vibration machine as disclosed herein.

The present invention relates to a damper for a vibration machine having a compensation system for compensating vibration forces generated by a vibrating mass. The vibration machine is preferably a vibrating conveyor for conveying bulk material and/or a screening machine for screening bulk material.

The damper is preferably designed to damp the transmission of vibrations from the vibration machine to a foundation connected to the damper and/or to reduce or compensate foundation loads introduced into a foundation by the vibration machine due to the vibration.

According to the invention, the compensation system has at least one spring with modifiable spring hardness. As a result, the damping properties of the compensation system can be adapted flexibly and/or in a targeted manner, in particular to changed vibration conditions. In particular, the natural frequency of the damper or compensation system can be changed. This makes it possible to adapt the vibration compensation to a changed drive and/or vibration frequency of the vibration machine and/or to a changed vibrating mass.

The spring with modifiable spring hardness is preferably a pneumatic and/or hydraulic spring, preferably an air spring or a bellows cylinder. In particular, the spring hardness is modifiable via a gas and/or fluid pressure within the spring. This enables a simple, rapid and/or electronically controllable adaptation and/or change of the spring hardness and is furthermore cost-effective.

The compensation system preferably has two springs with modifiable spring hardness which are arranged on opposite sides of a bearing point of the damper and/or symmetrically with respect to the bearing point and/or are coupled to the bearing point and/or which jointly act as a tension-compression spring. The springs are preferably identically constructed.

Preferably, the compensation system has a spring pair composed of two, in particular identically constructed, springs with modifiable spring hardness, wherein the springs of the spring pair are arranged in such a way that, in the case of positive displacement of a damper mass from a rest position, one of the springs of the spring pair is compressed and, in the case of negative displacement of the damper mass from the rest position, the other spring of the spring pair is compressed. This is conducive to optimal vibration damping.

The mentioned arrangement of the two springs and/or of the spring pair enables an effective damping and/or compensation of vibrations, in particular since a change and/or adaptation of the spring hardness and/or of the natural frequency of the compensation system is made possible by the arrangement.

Preferably, the compensation system has at least one spring, preferably a plurality of springs, with unmodifiable spring hardness. This is cost-effective and enables a damping and/or vibration compensation even in the case of large vibrating masses. Furthermore, an optimal compromise between an adaptability of the vibration compensation, on the one hand, and a cost-effective and simple construction which is suitable for compensating large vibration forces, on the other hand, is achieved by the combination of the spring(s) with modifiable spring hardness with spring(s) with unmodifiable spring hardness.

The spring with modifiable spring hardness is preferably connected and/or arranged parallel to the spring with unmodifiable spring hardness. In this way, the acting forces are distributed to the various springs and an adjustment and/or change of the spring hardness of the compensation system is made possible. In particular, the advantages of the various spring types are combined by the parallel connection of the springs so that the parallel connection represents an optimal compromise.

The spring with unmodifiable spring hardness is preferably designed as a coil spring and/or tension-compression spring. In principle, other springs, such as leaf springs, can also be used. Such springs are cost-effective, low-maintenance, simple to assemble and have a long service life. Furthermore, they can be produced with almost any spring hardnesses and are also suitable for damping in the case of high forces due to large vibrating masses from several hundred kilograms up to over one thousand kilograms.

Preferably, the compensation system has a first spring arrangement and a second spring arrangement, wherein the first spring arrangement couples a bearing point of the damper to the vibrating mass and the second spring arrangement couples the bearing point to a damper mass, wherein at least one of the spring arrangements has at least one spring with modifiable spring hardness and at least one spring with unmodifiable spring hardness connected and/or arranged parallel thereto. As a result, the advantages of the various spring types are combined and an optimal compromise is achieved when fulfilling different requirements.

Particularly preferably, only one of the spring arrangements, in particular the second spring arrangement, has the spring or springs with modifiable spring hardness. It has been shown that as a result, the desired adaptability of the vibration compensation and/or of the natural frequency of the damper can already be realized.

The damper preferably has a deflection device with a deflection lever via which the vibrating mass is coupled to a damper mass so that the damper mass and the vibrating mass perform anti-phase vibrations. The deflection lever preferably has two lever arms with a lever arm ratio which corresponds approximately to the mass ratio of vibrating mass to damper mass. Particularly preferably, the two lever arms have a lever arm ratio of approximately 2:1, in particular so that a displacement of the vibrating mass is deflected into a displacement of the damper mass which is approximately twice as large. The lever arm ratio corresponds approximately to the ratio of the masses in order to achieve the required vibration width ratio. The deflection enables the use of a damper mass which is smaller than the vibrating mass. With a lever arm ratio of 2:1, for example, the damper mass only has to be half the vibrating mass for optimal vibration damping and/or compensation. This is costsaving, material-saving and facilitates the production and installation and/or startup of the damper and/or of the vibration machine.

The deflection lever is preferably coupled to the damper mass via a spring device. It has been shown that as a result, the vibration compensation can be further optimized.

The damper and/or the compensation system is/are preferably designed for mechanical and/or passive vibration compensation. This has the advantage that the damper is cost-effective and low-maintenance compared to other solutions, in particular so-called active systems.

The damper preferably has an electronic control and/or feedback control for the in particular automatic and/or adaptive adjustment of the spring hardness of the spring with modifiable spring hardness. This enables the adjustment and/or change of the spring hardness of the compensation system when the damper is installed and/or during operation.

According to a further aspect, the present invention relates to a vibration machine, in particular a vibrating conveyor for conveying bulk material and/or a screening machine for screening bulk material, having one or more dampers designed as described herein. The advantages of the damper are correspondingly achieved by the vibration machine.

The aforementioned aspects and features of the present invention and the aspects and features of the present invention resulting from the claims and the following description can in principle be realized independently of one another, but also in any desired combination.

Further aspects, advantages, features and properties of the present invention result from the claims and the following description of preferred embodiments with reference to the figures. In the figures:

### BRIEF DESCRIPTION OF THE DRAWINGS

FIG. 1 shows a schematic sketch of a damper according to the invention;

FIG. 2 shows a perspective illustration of a damper according to the invention;

FIG. 3 shows the perspective illustration of the damper according to FIG. 2 with a central section through the damper;

FIG. 4 shows a sectional illustration of the damper according to FIGS. 2 and 3; and

FIG. 5 shows a side view of a vibration machine according to the invention with several dampers according to the invention.

### DETAILED DESCRIPTION

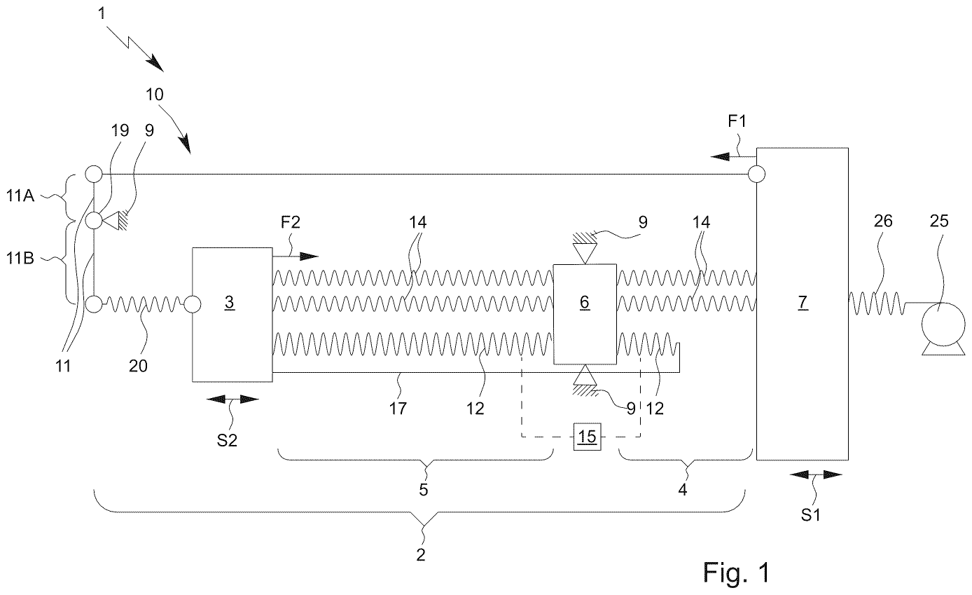

FIG. 1 shows a damper 1 according to the invention with a compensation system 2 in a schematic sketch. Dampers 1 as described herein are sometimes also referred to as “vibration dampers”.

The damper 1 and/or the compensation system 2 preferably has a damper mass 3, a first spring arrangement 4, a second spring arrangement 5, and/or a bearing point 6. Preferably, the first spring arrangement 4 and/or the second spring arrangement 5 is/are supported on the bearing point 6.

A spring arrangement in the sense of the present invention has at least one spring, preferably a plurality of springs, or consists thereof. The springs of a spring arrangement preferably act between the same components and/or are arranged between the same components. A spring arrangement can in particular have a plurality of springs arranged and/or acting parallel. In the sense of the present invention, springs which are not arranged and/or do not act between the same components preferably do not form a spring arrangement and/or are not part of the same spring arrangement.

A bearing point in the sense of the present invention is preferably a part or component of a damper which is at least substantially unmoved and/or stationary. In particular, the bearing point is rigidly connected or connectable to a foundation.

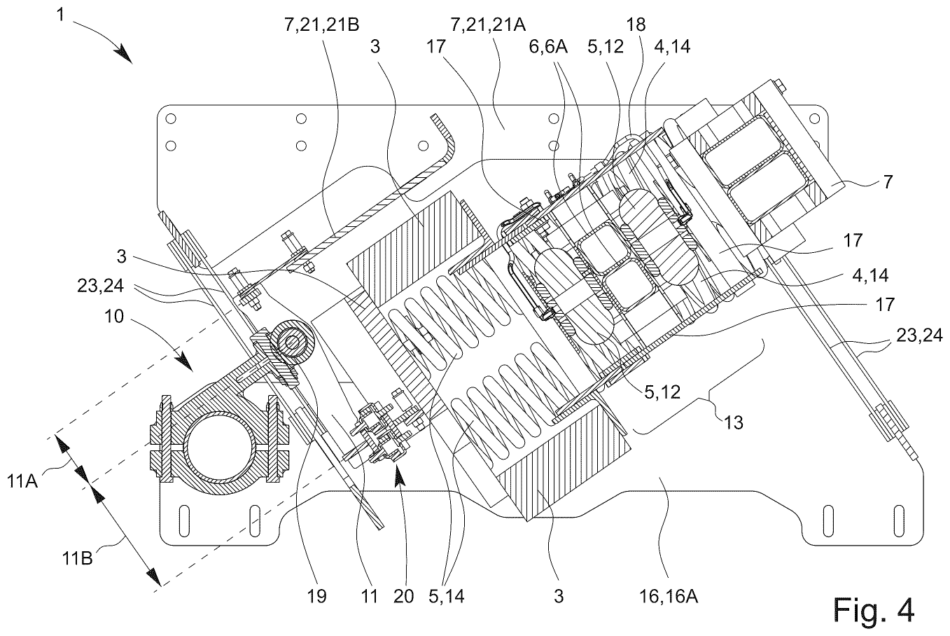

The damper 1 is preferably designed to compensate vibrations S1 of a vibrating mass 7. For this purpose, the damper 1 is preferably couplable and/or coupled to the vibrating mass 7. Further preferably, the damper 1 also has at least a small part of the vibrating mass 7, which preferably has a plurality of components. Predominantly, however, the vibrating mass 7 is preferably not part of the damper 1. The vibrating mass 7 is preferably formed at least predominantly by a part of a vibration machine 8 (not illustrated further in FIG. 1 but shown in FIG. 4), in particular a trough of the vibration machine 8 or the like, and/or bulk material which is processed, in particular conveyed, with the vibration machine 8.

The damper 1 is preferably a part of a vibration machine 8 and/or integrated into a vibration machine 8.

The vibrating mass 7 is preferably coupled and/or connected to the bearing point 6 and/or supported on the bearing point 6 via the first spring arrangement 4. The first spring arrangement 4 is thus preferably arranged between the bearing point 6 and the vibrating mass 7.

During operation of the vibration machine 8, the vibrating mass 7 executes vibrations S1, as indicated by the double arrow in FIG. 1. Thus, vibration forces F1 caused by the vibrations S1 of the vibrating mass 7 act on the bearing point 6.

The damper 1, in particular the bearing point 6, is preferably couplable and/or coupled to a foundation 9, which is only schematically indicated in FIG. 1, during operation of the damper 1 and/or the vibration machine 8. In particular, the damper 1 is fixedly and/or rigidly connectable and/or connected to the foundation 9 via the bearing point 6. Thus, the vibration forces preferably act on the foundation 9 and/or result in dynamic foundation loads.

Dynamic foundation loads in the sense of the present invention are in particular forces and/or loads which are caused by vibrations S1 of the vibrating mass 7 and/or are transmitted into the foundation 9. In particular, the pure weight of the vibrating mass 7 and/or the vibration machine 8 does not constitute a dynamic foundation load, but rather a static foundation load.

The damper 1 serves and/or is designed to compensate the dynamic foundation loads and/or vibration forces at least partially, preferably as completely as possible. For this purpose, the damper 1 has the compensation system 2.

The basic idea of the damper 1 is to generate vibrations and/or forces of equal magnitude and anti-phase with respect to the vibration forces so that the forces acting on the bearing point 6 are compensated. In other words, a dynamic or time-dependent force F1(t) is exerted on the bearing point 6 by the vibrations S1 of the vibrating mass 7, wherein the damper 1 is designed to exert a dynamic and/or time-dependent force F2(t) on the bearing point 6, wherein at least approximately F2(t)=−1(t) applies so that at least approximately F(t)=F1(t)+F2(t)=0 applies for the forces F(t) acting overall on the bearing point 6.

For this purpose, the damper 1 has the damper mass 3. The damper mass 3 preferably exerts the aforementioned force F2 on the bearing point 6 and/or is designed for this purpose.

The damper mass 3 preferably has at least one solid and/or block-like component with a large mass and/or a large weight, preferably in the range of several hundred kilograms, or consists thereof. The damper mass 3 and/or the mentioned component preferably consists of metal or another material with a high density.

In particular, the damper mass 3 thus has one or a plurality of metal blocks, which preferably makes up/make up at least a large part of the weight of the damper mass 3. However, further components which are rigidly connected to the metal block and/or the metal blocks and/or vibrate together therewith are preferably also part of the damper mass 3.

The damper mass 3 is preferably coupled and/or connected to the bearing point 6 and/or supported on the bearing point 6 via the second spring arrangement 5. The second spring arrangement 5 is in particular arranged between the bearing point 6 and the damper mass 3. The second spring arrangement 5 and the damper mass 3 are preferably arranged in such a way that they counteract the first spring arrangement 4 and the vibrating mass 7 and/or compensate the forces which are exerted on the bearing point 6 by the vibrating mass 7 via the first spring arrangement 4.

The damper mass 3 is preferably coupled to the vibrating mass 7.

In particular, the damper 1 has a deflection device 10 with a deflection lever 11 via which the damper mass 3 is coupled to the vibrating mass 7. By the deflection lever 11, it is in particular achieved that the vibration S2 of the damper mass 3 is antiphase with the vibration S1 of the vibrating mass 7.

By the deflection device 10 and/or the deflection lever 11, in particular a two-sided lever with two lever arms 11A, 11B is realized. The (first) lever arm 11A is connected and/or connectable to the vibrating mass 7, in particular via a connection 12 of the deflection device 10. The (second) lever arm 11B is connected to the damper mass 3.

The lever arm ratio of the lever arms 11B, 11A is preferably selected with reference to the ratio of the vibrating mass 7 to the damper mass 3, in particular so that the lever arm ratio of the lever arms 11B, 11A corresponds approximately to the ratio of vibrating mass 7 to damper mass 3.

Preferably, the lever arm ratio of the lever arms 11B, 11A is approximately 2:1. In other words, the (second) lever arm 11B which is connected to the damper mass 3 is preferably at least substantially twice as long as the (first) lever arm 11A which is connected to the vibrating mass 7. As a result, the displacement of the damper mass 3 during a vibration S2 is at least substantially twice the displacement of the vibrating mass 7 during a vibration S1 and the vibration S2 of the damper mass 3 is antiphase with the vibration S1 of the vibrating mass 7.

The vibrating mass 7 and/or the damper mass 3 preferably has/have a weight of at least 100 kg or more, particularly preferably at least 500 kg or more, in particular at least 1000 kg or more.

Furthermore, the weight G7 of the vibrating mass 7 is preferably at least substantially twice the weight G3 of the damper mass 3 (G7:G3≈2:1).

The first spring arrangement 4 has a spring hardness K4 and the second spring arrangement 5 has a spring hardness K5. Preferably, the spring hardness K4 is at least substantially twice as large as the spring hardness K5 (K4:K5≈2:1).

The spring hardness is in particular a measure for the ratio of the force acting on a spring to the displacement of the spring caused thereby.

In this way, the system of damper mass 3 and second spring arrangement 5 preferably has at least substantially the same natural frequency ω as the system of vibrating mass 7 and first spring arrangement 4. The natural frequency ω is proportional to the root of the quotient of the spring hardness k and the mass m (ω∝\sqrt{k/m}). In addition, the force F1 which the vibrating mass 7 exerts on the bearing point 6 via the first spring arrangement 4 is (ideally exactly) compensated by the force F2 which the damper mass 3 exerts on the bearing point 6 via the second spring arrangement 5.

The above explanations relate to an idealized view with reference to the sketch from FIG. 1. In reality, exact compensation of the vibration forces of the vibrating mass 7 is more difficult. This is in particular due to the fact that the vibrating mass 7, on the one hand, is not exactly known and, on the other hand, can change during operation of the vibration machine 8 when a part of the bulk material to be processed with the vibration machine 8 “couples” to the vibration machine 8 and/or forms a part of the vibrating mass 7.

In the following description of aspects, features and properties of the present invention, reference is made jointly to FIGS. 1 to 4.

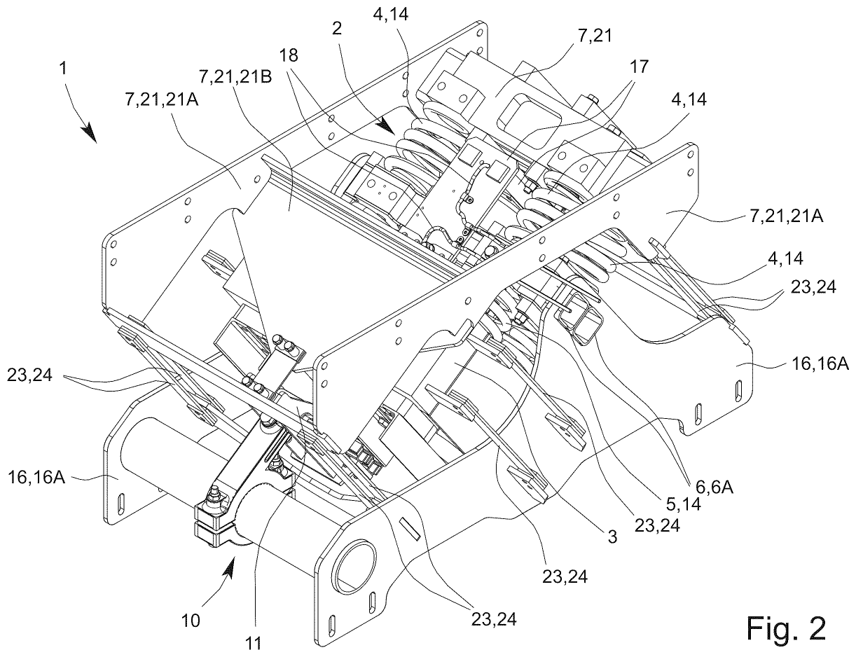

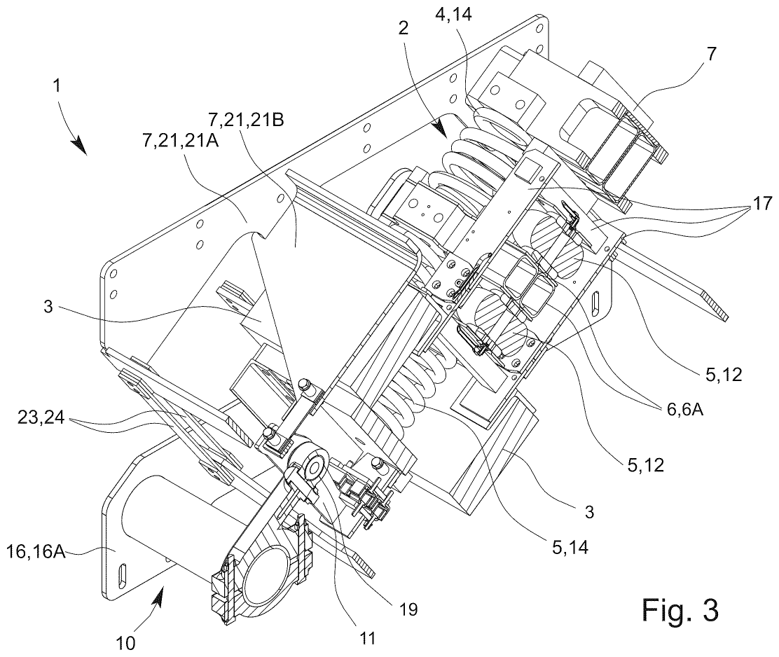

FIG. 2 shows a damper 1 according to the invention in a perspective view. FIG. 3 shows the damper 1 in a perspective sectional illustration. FIG. 4 shows the damper 1 in a sectional illustration, wherein the sectional plane in FIG. 4 is the same as in FIG. 3.

Preferably, a spring hardness of the damper 1 and/or compensation system 2 or of a part thereof, in particular of the second spring arrangement 5, is modifiable, in particular during operation of the damper 1 and/or the vibration machine 8. In particular, the spring hardness of the compensation system 2 or of a part of the compensation system 2 is modifiable without exchanging parts, in particular springs, and/or is modifiable by changing the spring properties, in particular spring hardnesses, of the spring arrangements 4, 5 and/or of the springs thereof.

The spring hardness of the compensation system 2 and/or of the first and/or second spring arrangement 4, 5 preferably results from the spring hardnesses of the respective springs, in particular from an addition of the spring hardnesses and/or of the reciprocal values of the spring hardnesses of the springs, depending on whether the springs are connected in parallel and/or in series.

The spring hardness of the first spring arrangement 4 is preferably at least 1000 N/mm or more and/or at most 6000 N/mm or less, in particular between 2000 N/mm and 4000 N/mm. In principle, however, substantially larger spring hardnesses of the first spring arrangement 4 are also possible.

The spring hardness of the second spring arrangement 5 is preferably approximately half the spring hardness of the first spring arrangement 4. The spring hardness of the second spring arrangement 5 is therefore preferably at least 500 N/mm or more and/or at most 3000 N/mm or less, in particular between 1000 N/mm and 2000 N/mm. In principle, however, substantially larger spring hardnesses of the second spring arrangement 5 are also possible.

According to the invention, the compensation system 2 has at least one spring 12 with modifiable spring hardness. Preferably, the first spring arrangement 4 has the spring 12 with modifiable spring hardness. This allows in particular an adjustment and/or adaptation of the spring hardness of the compensation system 2 or of a part thereof, in particular of the second spring arrangement 5. As a result, in particular the natural frequency can be adapted to the vibrating mass 7 and/or a change of the vibrating mass 7 and thus the compensation of the vibration forces can be optimized.

The spring 12 with modifiable spring hardness is preferably a pneumatic and/or hydraulic spring. A pneumatic and/or hydraulic spring is in particular a spring whose spring action is based on a pneumatic and/or hydraulic principle and/or whose spring hardness is pneumatically and/or hydraulically modifiable.

The spring hardness of the spring 12 is preferably modifiable during operation of the damper 1.

Particularly preferably, the spring 12 with modifiable spring hardness is an air spring or a bellows cylinder. In particular, the spring hardness is adjustable and/or modifiable via a gas and/or fluid pressure within the spring 12.

The compensation system 2 preferably has two, in the exemplary embodiment exactly two, springs 12 with modifiable spring hardness.

The springs 12 with modifiable spring hardness preferably form a spring pair 13, wherein the spring pair 13 has (exactly) two springs 12 which are assigned to one another and/or interact with one another or is formed therefrom.

In principle, the compensation system 2 can also have more than two springs 12 with modifiable spring hardness and/or more than one spring pair 13, in particular wherein the compensation system 2 has an even number of springs 12 with modifiable spring hardness. For such an embodiment, the following explanations, in which the exemplary embodiment with exactly two springs 12 with modifiable spring hardness is discussed above, apply correspondingly.

Preferably, the springs 12 with modifiable spring hardness, in particular the springs 12 of a spring pair 13, are identically constructed.

The two identically constructed springs 12 with modifiable spring hardness and/or the springs 12 of the spring pair 13 preferably together form a tension-compression spring and/or act together as a tension-compression spring.

A tension-compression spring in the sense of the present invention is in particular a spring which acts as a spring and/or opposes the movement of a spring both in the case of tensile loading or expansion from the rest position and in the case of compressive loading or compression from the rest position.

The two (identically constructed) springs 12 with modifiable spring hardness and/or springs 12 of the spring pair 13 are preferably arranged symmetrically with respect to the bearing point 6 and/or are arranged on opposite sides of the bearing point 6.

In particular, the two (identically constructed) springs 12 with modifiable spring hardness and/or springs 12 of the spring pair 13 are arranged in such a way that, in the case of positive displacement of the damper mass 3 from a rest position, one of the springs 12 (of the spring pair 13) is compressed and, in the case of negative displacement of the damper mass 3 from the rest position, the other spring 12 (of the spring pair 13) is compressed.

The damper mass 3 preferably vibrates at least substantially along a linear axis, as is schematically indicated in FIG. 1 by the double arrow which symbolizes the vibrations S2 of the damper mass 3. A “positive” and “negative” displacement of the damper mass 3 from the rest position are displacements from the rest position of the damper mass 3 along this linear axis in opposite directions. In particular, a positive displacement is a movement of the damper mass 3 from the rest position in the direction of the bearing point 6 and a negative displacement is a movement of the damper mass 3 from the rest position away from the bearing point 6 or vice versa. The rest position of the damper mass 3 is in particular the position of the damper mass 3 when it is not in vibration.

The compensation system 2, in particular the second spring arrangement 5, preferably has a frame 17. The frame 17 is preferably rigidly connected to the damper mass 3 and/or movable relative to the bearing point 6, in particular axially and/or parallel to the axis along which the damper mass 3 vibrates. The frame 17 is preferably of multi-part design. A part and/or section of the frame 17 can be formed by the damper mass 3 itself.

The frame 17 is in particular designed to deflect a vibration force of the damper mass 3 such that it acts on the bearing point 5 on a side opposite the damper mass 3 and/or acts on the bearing point 6 from the same side as the vibrating mass 7.

In particular, the frame 17 enables an arrangement of springs 12 with modifiable spring hardness on various and/or opposite sides of the bearing point 6 and/or an arrangement of springs 12 with modifiable spring hardness which acts as a tension-compression spring.

Preferably, the spring pair 13 and/or the springs 12 with modifiable spring hardness of the second spring arrangement 5 is/are arranged within the frame 17 and/or the frame 17 surrounds the spring pair 13 and/or the springs 12 with modifiable spring hardness of the second spring arrangement 5. In particular, the springs 12 with modifiable spring hardness are in each case arranged and/or coupled to the frame 17 and the bearing point 6 in such a way that one of the springs 12 with modifiable spring hardness is compressed in the case of displacement of the damper mass 3 in the positive direction, in particular between the bearing point 6 and a first side of the frame 17, and that the other spring 12 with modifiable spring hardness is compressed in the case of displacement of the damper mass 3 in the negative direction, in particular between the bearing point 6 and a second side of the frame 17 opposite the first side.

The compensation system 2 preferably has at least one, preferably a plurality of, spring/s 14 with unmodifiable spring hardness.

Preferably, the first spring arrangement 4 has at least one spring 14 with unmodifiable spring hardness and/or at least one spring 14 with unmodifiable spring hardness is arranged between the bearing point 6 and the vibrating mass 7. Further preferably, the second spring arrangement 5 has at least one spring 14 with unmodifiable spring hardness and/or at least one spring 14 with unmodifiable spring hardness is arranged between the bearing point 6 and the damper mass 3.

It is therefore preferred that at least one of the spring arrangements 4, 5, in particular both the first spring arrangement 4 and the second spring arrangement 5, has/have at least one spring 14 with unmodifiable spring hardness. In the exemplary embodiment, the first and the second spring arrangement 4, 5 in each case have a plurality of springs 14 with unmodifiable spring hardness.

The spring/springs 14 with unmodifiable spring hardness is/are preferably (in each case) designed as a coil spring and/or as a tension-compression spring.

Preferably, at least one spring 12 with modifiable spring hardness is connected and/or arranged parallel to at least one spring 14 with unmodifiable spring hardness, in particular in the case of the second spring arrangement 5. This is schematically illustrated in particular in FIG. 1.

In this case, it is particularly preferred that only the second spring arrangement 5 has a spring 12 with modifiable spring hardness and at least one spring 14 with unmodifiable spring hardness arranged and/or connected parallel thereto.

In principle, however, it is possible that alternatively or additionally the first spring arrangement 4 has a spring 12 with modifiable spring hardness and at least one spring 14 with unmodifiable spring hardness arranged and/or connected parallel thereto.

The first spring arrangement 4 preferably has (exactly) two or four springs 14 with unmodifiable spring hardness, preferably wherein the first spring arrangement 4 has no spring 12 with modifiable spring hardness. The second spring arrangement 5 preferably has at least one, particularly preferably at least or exactly two, springs 12 with modifiable spring hardness and/or a spring pair 13 formed thereby, preferably wherein the second spring arrangement 5 has (exactly) two or four springs 14 with unmodifiable spring hardness. The number of springs 12, 14 of the first and second spring arrangement 4, 5 can in principle also be chosen differently, however.

The damper 1 and/or the compensation system 2 is/are preferably designed for (purely) mechanical and/or passive vibration compensation. The compensation of the vibrations and/or vibration forces thus takes place preferably by mechanically and/or passively operating components, in particular by the springs 12 with modifiable spring hardness, the springs 14 with unmodifiable spring hardness and/or the damper mass 3 or the interaction of these components.

In particular, the damper 1 has no electrical, motorized and/or actively controlled components for vibration compensation.

Regardless of this, the damper 1 preferably has an electronic control or feedback control 15 for the in particular automatic and/or adaptive adjustment, control and/or feedback control of the spring hardness of the compensation system 2, in particular of the second spring arrangement 5 and/or of the springs 12 with modifiable spring hardness. The control/feedback control 15 is preferably designed to adjust, adapt and/or change a pressure, in particular fluid pressure and/or air pressure, within the spring(s) 12 with modifiable spring hardness so that the spring hardness of this spring(s) 12 changes. The control/feedback control 15 is thus preferably designed to control and/or feedback control the spring hardness and/or the air and/or fluid pressure of the springs 12 with modifiable spring hardness.

In the sense of the present invention, purely mechanical and/or passive vibration compensation is also realized by the springs 12 with modifiable spring hardness in combination with the control/feedback control 15, since the electronic control/feedback control 15 is not actively involved in the vibration compensation and/or intervenes therein, but rather merely serves to adjust parameters which have an influence on the vibration compensation. The spring 12, the spring hardness of which is modifiable and/or changed by the control/feedback control 15, namely operates purely passively and/or mechanically and independently of the control/feedback control 15.

The damper 1 preferably has a hydraulic and/or pneumatic system. The hydraulic and/or pneumatic system is preferably coupled and/or connected to the springs 12 with modifiable spring hardness or has these. The hydraulic and/or pneumatic system preferably has the control/feedback control 15. Furthermore, the hydraulic and/or pneumatic system preferably has corresponding peripherals, for example lines 18 for supplying the springs 12 with modifiable spring hardness with compressed air or the like, a compressor (not illustrated) for generating compressed air or the like, a compressed air reservoir (not illustrated) or the like and/or a pump for conveying compressed air or the like.

The damper 1 preferably has a foundation connection 16. By means of the foundation connection 16, the damper 1 is fastenable and/or anchorable to a foundation 9, for example by screwing the foundation connection 16 to the foundation 9.

Preferably, the damper 1 is supported and/or supportable on the foundation connection 16 and/or the foundation connection 16 constitutes a support for the further components of the damper 1, in particular the compensation system 2. The foundation connection 16 preferably has one or more support feet of the damper 1 or forms these.

However, it is also possible that the damper 1 (during operation) is not supported directly on the foundation 9, but on parts, for example steel supports or the like, arranged between the foundation 9 and the damper 1 and/or foundation connection 16. Therefore, the damper 1 is preferably at least indirectly connected and/or connectable to the foundation 9 via the foundation connection 16.

The foundation connection 16 may be of multi-part design. In the exemplary embodiment, the foundation connection 16 has two sheets 16A, which are preferably arranged laterally on the damper 1 and/or extend at least substantially vertically in an operating position of the damper 1. However, other solutions are also possible here.

The bearing point 6 is preferably fixedly and/or rigidly connected or connectable to the foundation 9, in particular via the foundation connection 16. Preferably, the bearing point 6 has one or more profiles and/or struts 6A or is formed by these. The profiles/struts 6A preferably extend at least substantially horizontally. In the exemplary embodiment, the profiles/struts 6A are fixedly connected to the two lateral sheets 16A of the foundation connection 16 and arranged in apertures of these sheets 16A.

The deflection device 10 has an axis of rotation 19 about which the deflection lever 11 is rotatable. The axis of rotation 19 is preferably fixedly connected and/or coupled to the foundation 9, the foundation connection 16 and/or the bearing point 6.

The deflection lever 11 is preferably coupled to the damper mass 3 via a spring device 20. The spring device 20 preferably has one or a plurality of springs which are formed in particular by rubber elements. The rubber elements are preferably flexible and/or elastic. The spring device 20 enables in particular a different movement of the damper mass 3 and the vibrating mass 7. This is advantageous in particular in connection with the modifiable spring hardness of the compensation system 2 and/or the springs 12 with modifiable spring hardness. It has been shown that by using the spring device 20, a safe and stable operation of the damper 1 is made possible even when the spring hardness of the springs 12 is changed.

The spring hardness of the spring device 20 is preferably many times greater than the spring hardness of the first and/or second spring arrangement 4, 5. In particular, the spring hardness of the spring device 20 is at least five times or ten times as great as the spring hardness of the first and/or second spring arrangement 4, 5.

Preferably, the spring device 20 has a spring hardness of more than 20,000 N/mm, in particular more than 30,000 N/mm, and/or less than 50,000 N/mm. In principle, however, substantially larger spring hardnesses of the spring device 20 are also possible.

The damper 1 preferably has a trough connection or vibrating mass connection 21. By means of the vibrating mass connection 21, the damper 1 is fastenable or fastened to the vibrating mass 7, for example by screwing to the vibrating mass 7.

The vibrating mass connection 21 may be of multi-part design. In the exemplary embodiment, the vibrating mass connection 21 has two sheets 21A, which are preferably arranged laterally on the damper 1 and/or extend at least substantially vertically in an operating position of the damper 1. Furthermore, in the exemplary embodiment, the vibrating mass connection 21 has a connecting piece 21B which is designed for connecting the vibrating mass 7 or a conveying trough 22 of the vibration machine 8 to the deflection lever 11. The connecting piece 21B is preferably rigidly connected to the conveying trough 22 and/or the vibrating mass 7 on one side and is rigidly connected or connectable to the deflection lever 11 on another, in particular opposite, side. However, other solutions are also possible here.

The damper 1 preferably has a stabilizing device 23 for stabilizing the damper 1 and/or for stabilizing movements/vibrations of the damper 1 and/or its components.

The stabilizing device 23 preferably connects the foundation connection 16, in particular its sheets 16A, to the vibrating mass connection 21, in particular its sheets 21A.

The stabilizing device 23 preferably has one or more leaf springs 24. The leaf springs 24 are preferably arranged at least substantially vertically with respect to the (main) vibration direction of the damper mass 3 and/or of the vibrating mass 7.

The leaf springs 24 preferably consist of glass-fiber-reinforced plastic and/or are preferably torsionally stiff. The leaf springs 24 are in particular designed to avoid or to reduce vibrations of the damper mass 3 and/or of the vibrating mass 7 perpendicular to the main vibration direction.

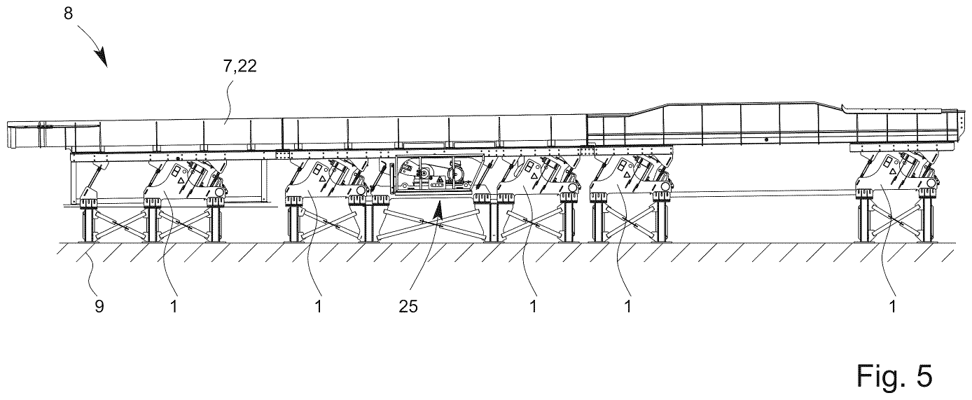

FIG. 5 shows a vibration machine 8 according to the invention in a side view.

The vibration machine 8 preferably has a plurality of dampers 1, in particular at least two or four dampers 1, particularly preferably at least six and/or at most twenty dampers 1.

The vibration machine 8 is preferably at least partially supported on the dampers 1 and/or connected to the foundation 9 via the dampers 1.

The dampers 1 are preferably integrated into the vibration machine 8.

The vibration machine 8 is preferably a vibrating conveyor for conveying bulk material or a screening machine for screening bulk material. In the exemplary embodiment according to FIG. 8, the vibration machine 8 is a vibrating conveyor.

The vibration machine 8 or the vibrating conveyor preferably has a conveying trough 22 for conveying bulk material. The conveying trough 22 can consist of a plurality of components connected to one another.

The conveying trough 22 preferably forms a part, in particular a large part, of the vibrating mass 7. Furthermore, at least a part of the bulk material conveyed with the conveying trough preferably also forms a part of the vibrating mass 7.

The vibration machine 8 preferably has a thrust crank drive 25 for driving the vibrating mass 7 and/or setting the vibrating mass 7 into vibration. The thrust crank drive 25 is preferably realized separately from the dampers 1. The thrust crank drive 25 is preferably connected and/or coupled to the vibrating mass 7 via a spring device 26, which is only schematically illustrated in FIG. 1, with at least one spring.

The spring device 26 is preferably softer than the first and/or second spring arrangement 4, 5. In particular, the spring hardness of the spring device 26 is at most half the spring hardness of the first and/or second spring arrangement 4, 5.

The damper 1 and/or the vibration machine 8 can have one or more measuring devices, in particular sensors, for measuring vibration data, in particular vibration directions, vibration amplitudes and/or vibration forces, of vibrations S1, S2 of the damper mass 3 and/or of the vibrating mass 7 and/or for measuring the dynamic foundation loads and/or forces acting on the bearing point 6.

The measuring devices are preferably connected in terms of signal technology to the control/feedback control 15 so that the control/feedback control 15 can receive measurement data from the measuring devices and, in particular on this basis, can adjust, control and/or feedback control the spring hardness of the spring(s) 12 with modifiable spring hardness.

Alternatively or additionally to the control on the basis of measurement data of the measuring devices, it is possible that the control takes place with reference to a predefined function or table. In the function or table, for example, a specific spring hardness (to be adjusted) of the spring(s) 12 can in each case be assigned to various values of one or more operating parameters of the damper 1 and/or of the vibration machine 8. Operating parameters can be, for example, a rotational speed, frequency and/or amplitude of the thrust crank drive 25 of the vibration machine 8.

In particular, it can be provided that tests and/or test measurements are carried out on a test setup with a damper 1 and/or a vibration machine 8, in which tests and/or test measurements the function or table is determined and/or created and the function or table determined in this way is then used to control dampers 1 and/or vibration machines 8 during operation, preferably wherein the dampers 1 and/or vibration machines 8 is/are identically constructed to the damper 1 and/or vibration machine 8 used in the test setup.

Analogously, it can also be provided that a function or table is created with a corresponding test setup, the various values of measurement data of the measuring devices are created and/or determined and the function or table determined in this way is then used to control dampers 1 and/or vibration machines 8 during operation, preferably wherein the dampers 1 and/or vibration machines 8 is/are identically constructed to the damper 1 and/or vibration machine 8 used in the test setup.

Individual aspects and features of the present invention can be realized independently of one another, but also in any desired combination.

### LIST OF REFERENCE SIGNS

1 damper
2 compensation system
3 damper mass
4 first spring arrangement
5 second spring arrangement
6 bearing point
6A struts
7 vibrating mass
8 vibration machine
9 foundation
10 deflection device
11 deflection lever
11A lever arm
11B lever arm
12 spring with modifiable spring hardness
13 spring pair
14 spring with unmodifiable spring hardness
15 control/feedback control
16 foundation connection
16A sheet of 16
17 frame
18 lines
19 axis of rotation
20 spring device
21 vibrating mass connection
21A sheet of 21
21B connecting piece of 21
22 conveying trough
23 stabilizing device
24 leaf springs
25 thrust crank drive
26 spring device
1 force of 7
F2 force of 3
S1 vibrations of 7
S2 vibrations of 3

1. A damper for a vibration machine,
the damper having a compensation system for compensating vibration forces generated by a vibrating mass,
wherein the compensation system has at least one spring with modifiable spring hardness.

2. The damper according to claim 1, wherein the spring with modifiable spring hardness is a pneumatic and/or hydraulic spring, wherein the spring hardness is modifiable via a gas and/or fluid pressure within the spring.

3. The damper according to claim 1, wherein the compensation system has two springs with modifiable spring hardness which are arranged on opposite sides of a bearing point of the damper and/or symmetrically with respect to the bearing point (6) and/or are coupled to the bearing point and/or which jointly act as a tension-compression spring.

4. The damper according to claim 1, wherein the compensation system has a spring pair composed of two springs with modifiable spring hardness, wherein the springs of the spring pair are arranged in such a way that, in the case of positive displacement of a damper mass from a rest position, one of the springs of the spring pair is compressed and, in the case of negative displacement of the damper mass from the rest position, the other spring of the spring pair is compressed.

5. The damper according to claim 1, wherein the compensation system has at least one spring with unmodifiable spring hardness.

6. The damper according to claim 5, wherein the spring with modifiable spring hardness is connected and/or arranged parallel to the spring with unmodifiable spring hardness.

7. The damper according to claim 5, wherein the spring with unmodifiable spring hardness is designed as a coil spring and/or tension-compression spring.

8. The damper according to claim 1, wherein the compensation system has a first spring arrangement and a second spring arrangement, wherein the first spring arrangement couples a bearing point of the damper to the vibrating mass and the second spring arrangement couples the bearing point to a damper mass, wherein at least one of the spring arrangements has at least one spring with modifiable spring hardness and at least one spring with unmodifiable spring hardness connected and/or arranged parallel thereto.

9. The damper according to claim 8, wherein the second spring arrangement has the spring/s with modifiable spring hardness.

10. The damper according to claim 1, wherein the damper has a deflection device with a deflection lever via which the vibrating mass is coupled and/or couplable to a damper mass so that the damper mass and the vibrating mass perform anti-phase vibrations.

11. The damper according to claim 10, wherein the deflection lever is coupled to the damper mass via a spring device.

12. The damper according to claim 1, wherein the damper and/or the compensation system is/are designed for mechanical and/or passive vibration compensation.

13. The damper according to claim 1, wherein the damper has an electronic control and/or feedback control for the adjustment of the spring hardness of the spring with modifiable spring hardness.

14. The damper according to claim 1, wherein the damper is designed to compensate the vibration forces at least to a large extent, so that dynamic foundation loads introduced into a foundation are reduced or compensated.

15. A vibration machine having one or more dampers, the dampers each having a compensation system for compensating vibration forces generated by a vibration mass, wherein the compensation system has at least one spring with modifiable spring hardness.

16. The damper according to claim 10, wherein the deflection lever has two lever arms with a lever arm ratio which corresponds approximately to the mass ratio of vibrating mass to damper mass.

17. The vibration machine according to claim 15, wherein the vibration machine is a vibrating conveyor for conveying bulk material and/or screening machine for screening bulk material.

18. The vibration machine according to claim 15, wherein the compensation system has a first spring arrangement and a second spring arrangement, wherein the first spring arrangement couples a bearing point of the damper to the vibrating mass and the second spring arrangement couples the bearing point to a damper mass, wherein at least one of the spring arrangements has at least one spring with modifiable spring hardness and at least one spring with unmodifiable spring hard-ness connected and/or arranged parallel thereto.

19. The vibration machine according to claim 15, wherein the damper has a deflection device with a deflection lever via which the vibrating mass is coupled and/or couplable to a damper mass so that the damper mass and the vibrating mass perform anti-phase vibrations.

20. The vibration machine according to claim 19, wherein the deflection lever has two lever arms with a lever arm ratio which corresponds approximately to the mass ratio of vibrating mass to damper mass.
